(19) United States
(12) Patent Application Publication
(10) Pub. No.: US 2009/0246608 A1
(43) Pub. Date: Oct. 1, 2009

(54) Rechargeable Electric Tool with a Battery Pack Detaching Device

(76) Inventors: Simon Wu, Taichung City (TW); Wei-Ting Chen, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/055,376

(22) Filed: Mar. 26, 2008

(51) Int. Cl. H01M 2/10

(52) U.S. Cl. 429/100; 361/747

(57) ABSTRACT

A battery pack detaching device includes an electric tool and a battery pack. The electric tool has a bottom cover having two slide blocks and two hooks. The battery pack has a battery cartridge, a detaching unit and a top cover. The detaching unit is mounted on the battery cartridge and includes a push button and two push blocks corresponding respectively to the hooks. The top cover is mounted on the detaching unit and has two sockets corresponding to the slide blocks, two mounting slots corresponding to the hooks and a button hole corresponding to the push button. The battery pack can be detached easily from the bottom cover by pushing the push button and moving for a short distance.

### BACKGROUND OF THE INVENTION

1. Field of Invention

The present invention relates to an electrical tool, and more particularly to a rechargeable electric tool with a battery pack detaching device.

2. Description of the Related Art

With reference to FIGS. 7 and 8, a conventional rechargeable electric tool comprises an electric tool (30) and a battery pack (40). The electric tool (30) has a bottom cover (31) having a bottom plate (311) and two hooks (312) formed on the bottom plate (311). Each hook (312) has an inner surface and a recess (3121) formed in the inner surface.

The battery pack (40) has a top surface, two sides, two rails (41) and two push buttons (42). The rails (41) are formed on the top surface of the battery pack (40) and respectively correspond to and engage the hooks (312). The push buttons (42) are formed respectively on the sides of the battery pack (40), and each push button (42) has a top and a protrusion (421). The protrusion (421) is formed on the top of the push button (42), protrudes from beneath one of the rails (41) and corresponds to the recess (3121) of one of the hooks (312).

When the battery pack (40) is mounted on the bottom cover (31), the rails (41) slide respectively in the hooks (312) and the protrusions (421) are mounted respectively in the recesses (3121) of the hooks (312) to position the battery pack (40). When the battery pack (40) is detached form the bottom cover (31), the push buttons (42) are pressed down to release the protrusions (421) from the recesses (3121) and detach the battery pack (40) from bottom cover (31).

However, because the conventional detaching device uses the push buttons (42) and the rails (41) to mount or detach the battery pack (40), the conventional detaching device has the following problems:

1. Both of the push buttons (42) must be pressed down at the same time to detach the battery pack (40), and it is inconvenient to operate if a user has small palms or the push buttons (42) are respectively pressed down with uneven forces.

2. The battery pack (40) must slide in or out for a long distance to mount onto or detach from the bottom cover (31), and this is also inconvenient in use.

To overcome the shortcomings, the present invention provides a rechargeable electric tool to mitigate or obviate the aforementioned problems.

### SUMMARY OF THE INVENTION

The primary objective of the present invention is to provide a rechargeable electric tool having a battery pack detaching device that is easy to mount and detach.

A rechargeable electric tool in accordance with the present invention comprises an electric tool and a battery pack. The electric tool has a bottom cover having two slide blocks and two hooks. The battery pack has a battery cartridge, a detaching unit and a top cover. The detaching unit is mounted on the battery cartridge and includes a push button and two push blocks corresponding respectively to the hooks. The top cover is mounted on the detaching unit and has two sockets engaging the slide blocks, two mounting slots engaging the hooks and a button hole engaging the push button. The battery pack can be detached easily from the bottom cover by pushing the push button and moving for a short distance.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rechargeable electric tool in accordance with the present invention;

FIG. 2 is an exploded perspective view of the rechargeable electric tool in FIG. 1 with a battery pack detaching from a bottom cover;

FIG. 3 is an exploded perspective view of the battery pack of the rechargeable electric tool in FIG. 1;

FIG. 4 is a perspective view in partial section of the battery pack of the rechargeable electric tool in FIG. 1;

FIG. 5 is an enlarged side view in partial section of the battery pack of the rechargeable electric tool in FIG. 1;

FIG. 6 is an enlarged side view in partial section of the rechargeable electric tool in FIG. 1;

FIG. 7 is a perspective view of a conventional rechargeable electric tool; and

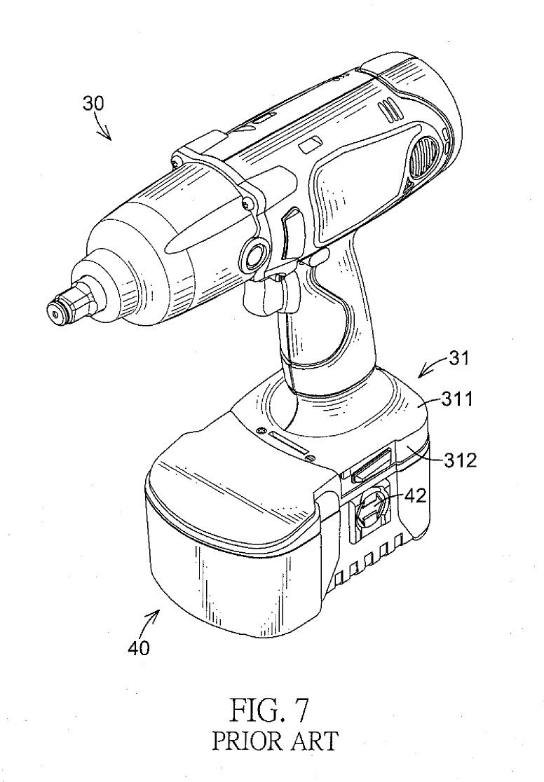

FIG. 8 is an exploded perspective view of the conventional rechargeable electric tool with a battery pack detaching from a bottom cover.

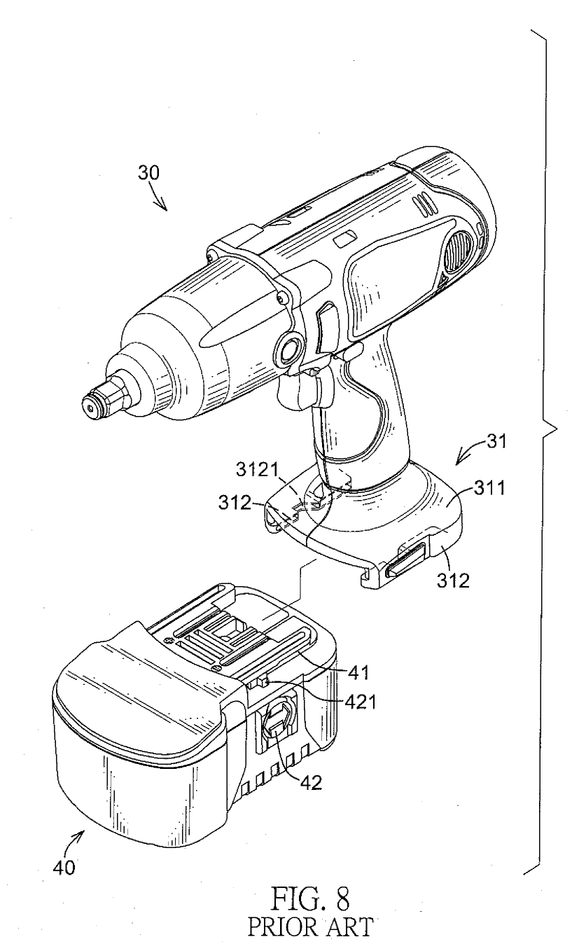

### DETAILED DESCRIPTION OF THE INVENTION

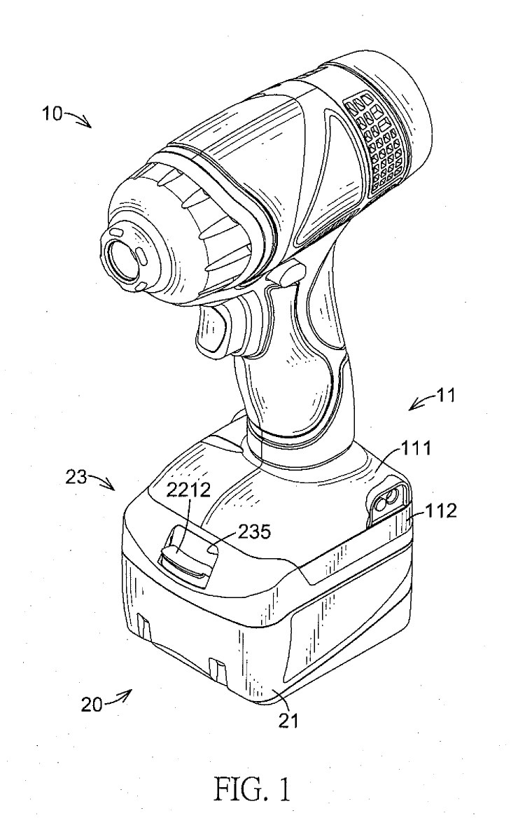

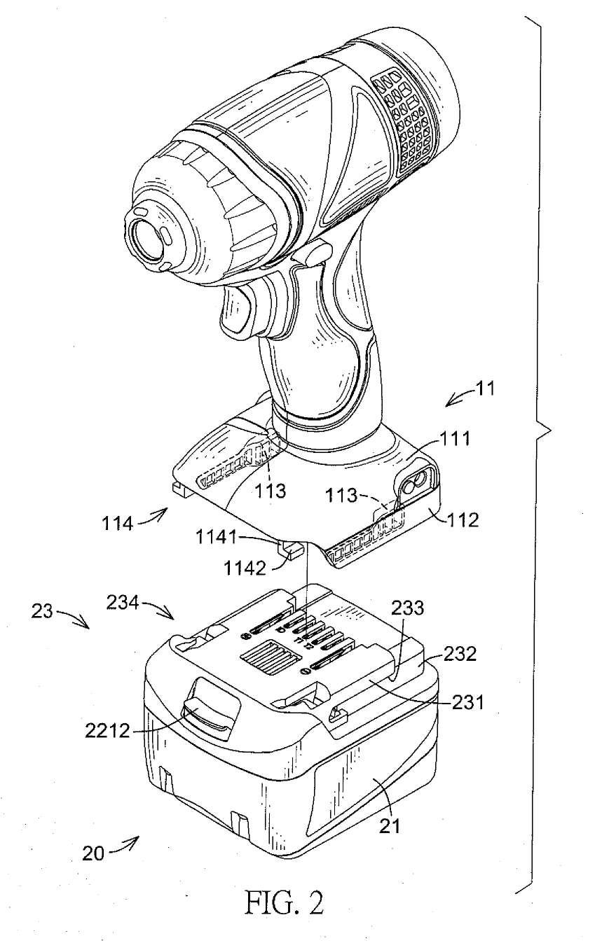

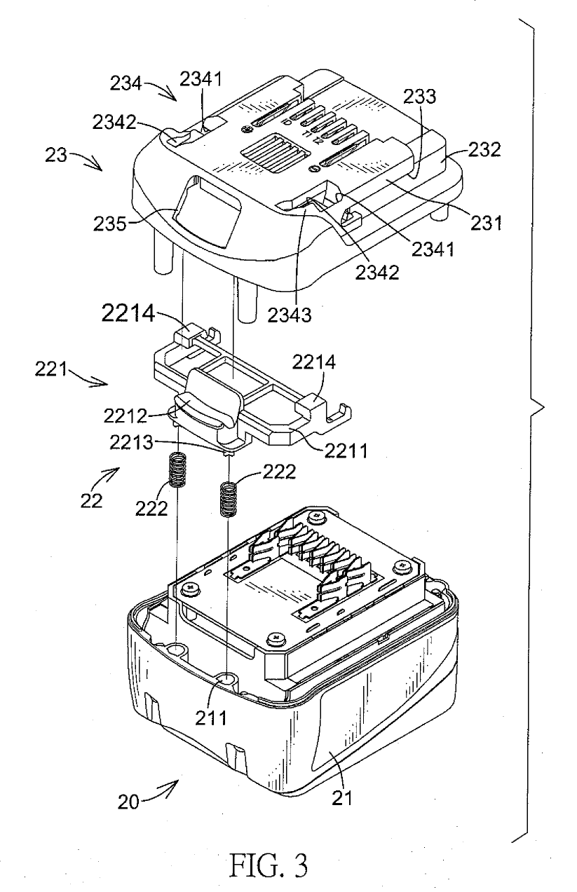

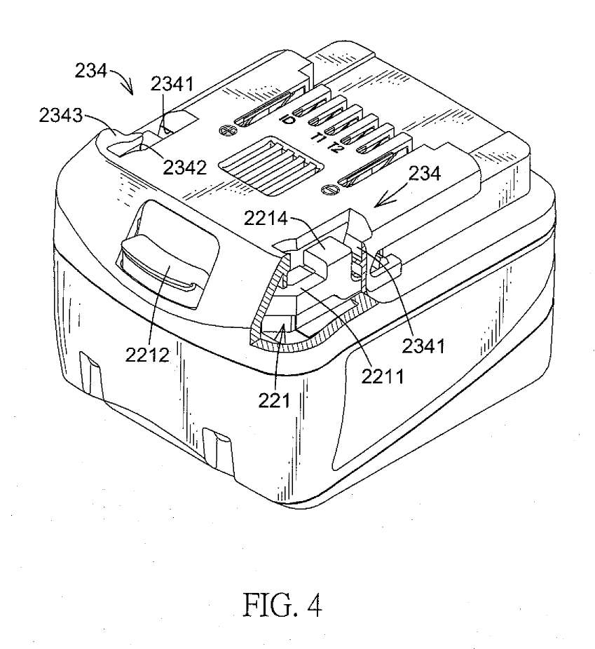

With reference to FIGS. 1 to 4, a rechargeable electric tool in accordance with the present invention comprises an electric tool (10) and a battery pack (20).

The electric tool (10) has a bottom end and a bottom cover (11) formed on the bottom end. The bottom cover (11) has a bottom plate (111), two side flanges (112), two slide blocks (113) and two hooks (114). The bottom plate (11) has a front end, a rear end and two sides. The side flanges (112) are formed respectively on the sides of the bottom plate (111) and each side flange (112) has an inner surface. The slide blocks (113) are formed respectively on the inner surfaces of the side flanges (112) near the rear end of the bottom plate (111). The hooks (114) are L-shaped, are formed on the front end and respectively near the sides of the bottom plate (111) and each hook (114) has an extending section (1141) and a hook section (1142). The extending section (1141) is connected to the bottom plate (111). The hook section (1142) is connected laterally to the extending section (1141) and extends opposite the hook section (1142) of the other hook (114).

The battery pack (20) is mounted detachably on the bottom cover (10) and has a battery cartridge (21), a detaching unit (22) and a top cover (23). The battery cartridge (21) has a top surface, a front end, two sides and two spring recesses (211). The spring recesses (211) are formed in the top surface in the front end and respectively near the two sides of the battery cartridge (21).

The detaching unit (22) is mounted on the battery cartridge (21) and comprises a mounting member (221) and two springs (222). The mounting member (221) has a connecting plate (2211), a push button (2212), two positioning posts (2213) and two push blocks (2214). The connecting plate (2211) is mounted on the top surface near the front end of the battery cartridge (21) and has a front end, a rear end and two sides. The push button (2212) is formed on the front end of the connecting plate (2211) and has a bottom surface. The positioning posts (2213) are formed on the bottom surface of the push button (2212) and correspond respectively to the spring recesses (211). The push blocks (2214) are formed on the rear end respectively on the sides of the connecting plate (2211) and correspond respectively to the hooks (114) of the bottom cover (11). The springs (222) are mounted between the mounting member (221) and the battery cartridge (21), are mounted respectively in the spring recesses (211) of the battery cartridge (21) and abut respectively the positioning posts (2213).

The top cover (23) is mounted on the detaching unit (22) and has a top surface, a bottom surfaces a front end, a rear end, two sockets (233), two mounting slots (234) and a button hole (235). The two sockets (233) are formed on the top surface respectively on the two sides of the top cover (23) and correspond respectively to and engage the slide blocks (113) of the bottom cover (11). The mounting slots (234) are defined through the top surface of the top cover (23) near the front end respectively near the two sides of the top cover (23) and correspond respectively to and engage detachably the hooks (114). Each mounting slot (234) has an inserting section (2341) and a positioning section (2342). The inserting section (2341) is defined above one of the push blocks (2214) and corresponds to the hook section (1142) of one of the hooks (114). The positioning section (2342) is defined in front of and narrower than the inserting section (2341) and corresponds to the extending section (1141) of the corresponding one of the hooks (114). The button hole (235) is defined in the front end of the top cover (23) and corresponds to and engages the push button (234) of the mounting member (221).

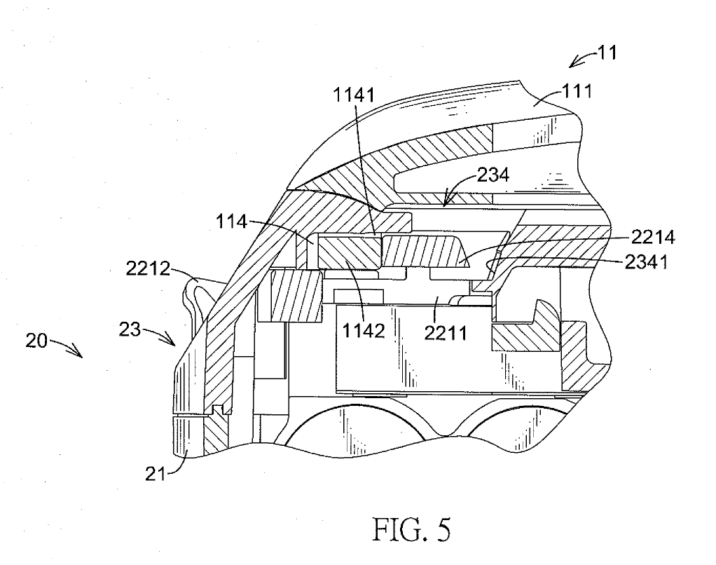

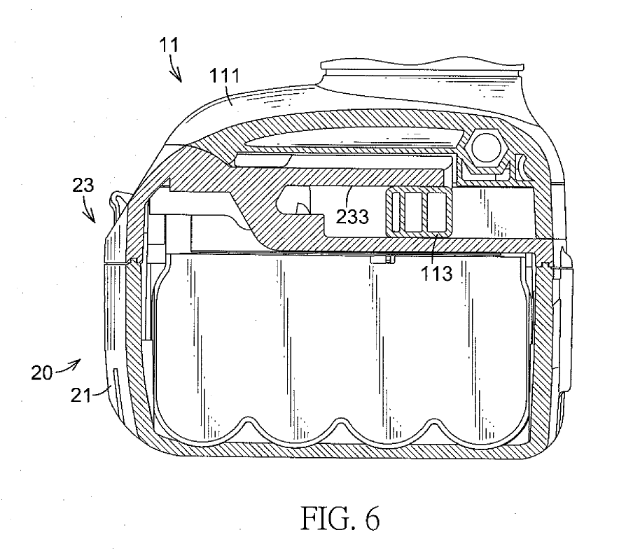

When the battery pack (20) is mounted on the bottom cover (11), the hooks (114) are inserted respectively into the inserting sections (2341) of the mounting slots (234) and press the push blocks (2214) down with compressing the springs (222). With reference to FIGS. 5 and 6, then the battery pack (20) is moved to slide the extending sections (1141) of the hooks (114) respectively along the positioning sections (2342) of the mounting slots (234). The slide blocks (113) of the bottom cover (11) also slide respectively along the sockets (233) of top cover (23). When the hooks (114) move over the push block (2214), the push blocks (2214) are moved upward by the recoil force provided by the springs (222) to keep the hooks (114) securely engaging inside and from escaping from the mounting slots (234). The bottom surface of the top cover (23) beside the positioning sections (2342) wedge the hook sections (1142) of the hooks (114) to prevent the hooks (114) from escaping from the mounting slots (234) in an upward direction. Accordingly, the hooks (114) are positioned securely in the mounting slots (234), and the electric tool (11) is securely combined with the battery pack (20).

When the battery pack (20) is detached from the bottom cover (11), the push button (2212) is pushed to compress the springs (222) and the push blocks (2214) are moved downward to release the hooks (114). Then, the battery pack (20) is moved in reverse to slide the hooks (114) out from the positioning sections (2342) and the slide blocks (113) out from the sockets (233). Finally, the battery pack (20) is moved downward and is detached from the bottom cover (11). Because the battery pack (21) can be detached from the bottom cover (11) by pushing the push button (2212) with only one finger, detaching the battery pack (20) from the electric tool (10) is convenient. Additionally, because the battery pack (20) needs only to move for a short distance when mounting on or detaching from the bottom cover (11), mounting or detaching the battery pack (20) are convenient.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A rechargeable electric tool comprising
an electric tool having
a bottom end; and
a bottom cover being formed on the bottom end and having F
a bottom plate having
a front end;
a rear end; and
two sides;
two side flanges being formed respectively on the sides of the bottom plate and each side flange having an inner surface;
two slide blocks being formed respectively on the inner surfaces of the side flanges near the rear end of the bottom plate; and
two hooks being formed on the front end respectively near the sides of the bottom plate, and each hook having
an extending section being connected to the bottom plate; and
a hook section being connected laterally to the extending section; and
a battery pack detachably combined with the electric tool and having
a battery cartridge having
a top surface;
a front end; and
two sides;
a detaching unit being mounted on the battery cartridge and comprising
a mounting member having
a connecting plate being mounted on the top surface near the front end of the battery cartridge and having
a front end;
a rear end; and
two sides;
a push button being formed on the front end of the connecting plate and having a bottom surface; and
two push blocks being formed on the rear end and respectively on the sides of the connecting plate and corresponding respectively to the hooks; and
at least one spring being mounted between the push button and the battery cartridge; and
a top cover being mounted on the detaching unit and having
a top surface;
a bottom surface;
a front end;
a rear end;
two sockets being formed on the top surface and respectively on the two sides of the top cover and corresponding respectively to and engaging detachably the slide blocks of the bottom cover;
two mounting slots being defined through the top surface near the front end respectively near the two sides of the top cover and corresponding respectively to and engaging detachably the hooks, and each mounting slot having
an inserting section being defined above one of the push blocks and corresponding to the hook section of one of the hooks; and
a positioning section being defined in front of and narrower than the inserting section and corresponding to the extending section of a corresponding one of the hooks; and
a button hole being defined in the front end of the top cover, corresponding to and engaging the push button of the mounting member.

2. The rechargeable electric tool as claimed in claim 1, wherein
the battery cartridge further has two spring recesses formed in the top surface in the front end respectively near the two sides of the battery cartridge; and
the mounting member has two positioning posts formed on the bottom surface of the push button and corresponding respectively to the spring recesses; and
the detaching unit comprises two springs mounted respectively in the spring recesses and abutting respectively the positioning posts.

3. The rechargeable electric tool as claimed in claim 2, wherein the hooks are L-shaped and the hook section of each hook extends opposite the hook section of the other hook.
